(19) United States
(12) Patent Application Publication
(10) Pub. No.: US 2023/0105168 A1
(43) Pub. Date: Apr. 6, 2023

(54) GATEWAY APPARATUS, METHOD AND PROGRAM

(71) Applicant: NIPPON TELEGRAPH AND TELEPHONE CORPORATION, Tokyo (JP)

(72) Inventors: Takayuki NAKAMURA, Musashino-shi, Tokyo (JP); Shunsuke HOMMA, Musashino-shi, Tokyo (JP); Tomohiro OKADA, Musashino-shi, Tokyo (JP); Takuya SATO, Musashino-shi, Tokyo (JP); Mitsuo AMASAKA, Musashino-shi, Tokyo (JP)

(21) Appl. No.: 17/904,608

(22) PCT Filed: Feb. 21, 2020
(86) PCT No.: PCT/JP2020/007226

§ 371 Date: Aug. 19, 2022

(51) Int. Cl. H04L 45/76; H04L 45/74; H04L 12/46

(52) U.S. Cl. CPC H04L 45/76; H04L 45/74; H04L 12/4633

(57) ABSTRACT

A gateway apparatus according to an embodiment includes a transfer destination specification unit that refers to a slice transfer table for determining a tunnel for a transfer destination when a packet with a slice ID added is received, the slice requirement abstracted indicating a requirement related to transfer priority, reliability, and whether a network function is passed through and a gateway ID abstracted indicating a gateway apparatus to be a destination and specifies a tunnel corresponding to the slice requirement and the gateway ID that are included in the slice ID and a transfer unit that transfers the packet with the tunnel specified by the destination specification unit.

### TECHNICAL FIELD

The present invention relates to a gateway apparatus, a method, and a program.

### BACKGROUND ART

In recent years, practical use of the 5th generation (5G) mobile communication system has been in progress. The practical use of 5G is expected to create new services in cooperation with various operators utilizing 5G characteristics including large capacity broadband, large session connection, ultra-low latency and high quality. Achieving these new services needs a variety of networks according to various service requirements. A network slicing technique has been known as a technique for quickly and flexibly providing a network for such a request. The network slicing technique can manage an infrastructure of a common physical facility as a resource that can be virtually divided, freely combine the resources, and configure a required virtual network (slice).

In order to provide a network (hereinafter abbreviated as an “NW”) having a variety of requirements required by a service operator, an end-to-end (E2E) slice that can secure consistent communication quality at E2E is needed. The E2E slice is not necessarily an NW limited to a single NW operator/domain and may also be an NW across a plurality of NW operators/domains. For achieving such an E2E slice (hereinafter simply referred to as a “slice”) across a plurality of NW operators/domains, an architecture in which a slice gateway (SLG) is deployed at a connection point between NW operators/domains has been proposed.

For example, an architecture that achieves a slice by an NW configuration illustrated in FIG. 1 has been known. The NW configuration illustrated in FIG. 1 includes an access NW, a core NW, and an NW in data center (DC), and includes an SLG deployed at a connection point between the NWs. Here, a tunnel by type shared by a plurality of slices (for example, type determined by transfer priority, presence or absence of redundancy, and the like) is configured between SLGs, and the tunnels in domains are appropriately connected one another according to a requirement of a slice, achieving the slice (i.e., a virtual NW between a terminal and a server/virtual machine (VM)).

For example, a bandwidth guaranteed and highly reliable slice can be achieved by connecting tunnels with priority/path redundancy to each other. Specifically, a bandwidth guaranteed and highly reliable slice can be achieved by connecting a tunnel 1 of the access NW, a tunnel 5 of the core NW, and a tunnel 13 of the NW in DC, connecting a tunnel 3 of the access NW, a tunnel 9 of the core NW, and the tunnel 13 of the NW in DC, and the like.

Similarly, for example, a bandwidth guaranteed and highly reliable slice via a network function (NF) such as a firewall can be achieved by connecting tunnels with priority/path redundancy via the NF to each other. Specifically, a bandwidth guaranteed and highly reliable slice can be achieved by connecting the tunnel 1 of the access NW, a tunnel 7 of the core NW, and the tunnel 13 of the NW in DC, connecting the tunnel 3 of the access NW, a tunnel 12 of the core NW, and a tunnel 16 of the NW in DC, or the like.

Similarly, a best effort (BE) and highly reliable slice can be achieved, for example, by connecting tunnels with BE/path redundancy to each other. Specifically, a BE and highly reliable slice can be achieved by connecting a tunnel 2 of the access NW, a tunnel 6 of the core NW, and a tunnel 14 of the NW in DC, connecting a tunnel 4 of the access NW, a tunnel 10 of the core NW, and a tunnel 17 of the NW in DC, and the like. A BE and unreliable slice and the like are also achieved by appropriately connecting tunnels to each other. Note that, for example, a terminal is equipped with an application, and various services are provided to the terminal by application processing executed by a server/VM.

In the NW configuration described above, for example, by performing, by OpenFlow (NPL 1) or Policy Based Routing (NPL 2), assignment setting (output destination tunnel setting) by flow identification based on 5-tuple information (a source Internet Protocol (IP) address, a destination IP address, a source port number, a destination port number, and a protocol number), each SLG can determine an output destination tunnel of a packet and achieve a slice. Alternatively, for example, by performing flow identification based on 5-tuple information only at an NW endpoint by using a source routing technique such as Segment Routing (NPL 3) to specify a path, a slice can also be achieved.

CITATION LIST

### Non Patent Literature

NPL 1: ONF, “Software-Defined Networking: The New Norm for Networks”, ONF White Paper Apr. 13, 2012, Internet <URL: https://www.opennetworking.org/images/stories/downloads/sdn-resources/white-papers/wp-sdn-newnorm.pdf>

NPL 2: Cisco, “Policy-Based Routing (PBR)”, Internet <URL: https://www.cisco.com/c/ja_jp/td/docs/sw/campuslanswt-coredistribution/cat6500swt/cg/002/15-1-sy-c4-swcg/policy-based-routing-pbr.html>

NPL 3: IETF RFC8402, Internet <URL: https://www.rfc-editor.org/rfc/rfc8402.txt>

### SUMMARY OF THE INVENTION

### Technical Problem

However, for example, when assignment setting is performed on each SLG, a transfer table of an SLG (particularly, a transfer table of an SLG of an NW higher stage (such as a core NW) through which communication of many terminals passes) increases due to an increase in the number of terminals, the number of applications that use a slice, the number of servers/VMs, the number of address ranges used by a terminal, and the like. Further, for example, when an operator of each domain of the access NW, the core NW, and the NW in DC is different, a large number of pieces of assignment information needs to be exchanged between the operators, and lead time of the assignment setting increases (particularly, when the assignment setting is sequentially introduced in consideration of rollback, lead time of the assignment setting increases).

On the other hand, when, for example, a source routing technique such as Segment Routing is used, NW information such as an NW topology and address information in all domains needs to be managed in a domain at an NW endpoint, and a system load required for the management increases. Further, in an operation requiring a path change that requires quickness (for example, a path change during an abnormal condition such as failure and congestion of an SLG, and the like), a setting change of an SLG in another domain is required, and thus lead time for reflecting the setting increases.

An embodiment of the present invention has been made in view of the above-described circumstances, and an object thereof is to achieve an efficient E2E slice.

### Means for Solving the Problem

In order to achieve the object described above, a gateway apparatus according to an embodiment includes a transfer destination specification unit that refers to a slice transfer table for determining a tunnel for a transfer destination when a packet with a slice ID added is received, the slice ID including a slice requirement abstracted indicating a requirement related to transfer priority, reliability, and whether a network function is passed through and a gateway ID abstracted indicating a gateway apparatus as a destination, and specifies a tunnel corresponding to the slice requirement and the gateway ID that are included in the slice ID, and a transfer unit that transfers the packet with the tunnel specified by the transfer destination specification unit.

### Effects of the Invention

An efficient E2E slice can be achieved.

### BRIEF DESCRIPTION OF DRAWINGS

FIG. 1 is a diagram illustrating an example of an NW configuration that achieves a slice.

FIG. 2 is a diagram for describing an overview of transfer processing according to the present embodiment.

FIG. 3 is a diagram for describing preprocessing and the transfer processing according to the present embodiment.

FIG. 4 is a diagram illustrating an example of a 5-tuple-slice requirement correspondence table.

FIG. 5 is a diagram illustrating an example of a slice transfer table.

FIG. 6 is a diagram illustrating an example of an SLG-ID-address correspondence table.

FIG. 7 is a diagram illustrating an example of a functional configuration of an NW controller and an SLG according to the present embodiment.

FIG. 8 is a diagram for describing a flow of transfer processing according to an example.

FIG. 9 is a diagram illustrating an example of a hardware configuration of the NW controller according to the present embodiment.

FIG. 10 is a diagram illustrating an example of a hardware configuration of the SLG according to the present embodiment.

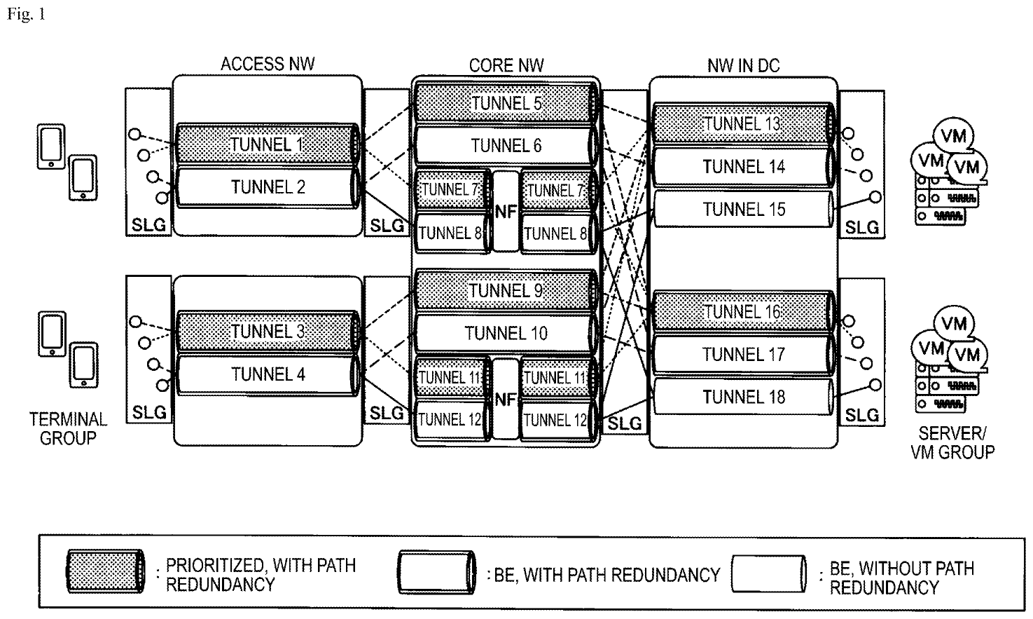

### DESCRIPTION OF EMBODIMENTS

Hereinafter, an embodiment of the present invention will be described.

Overview of Transfer Processing according to Present Embodiment

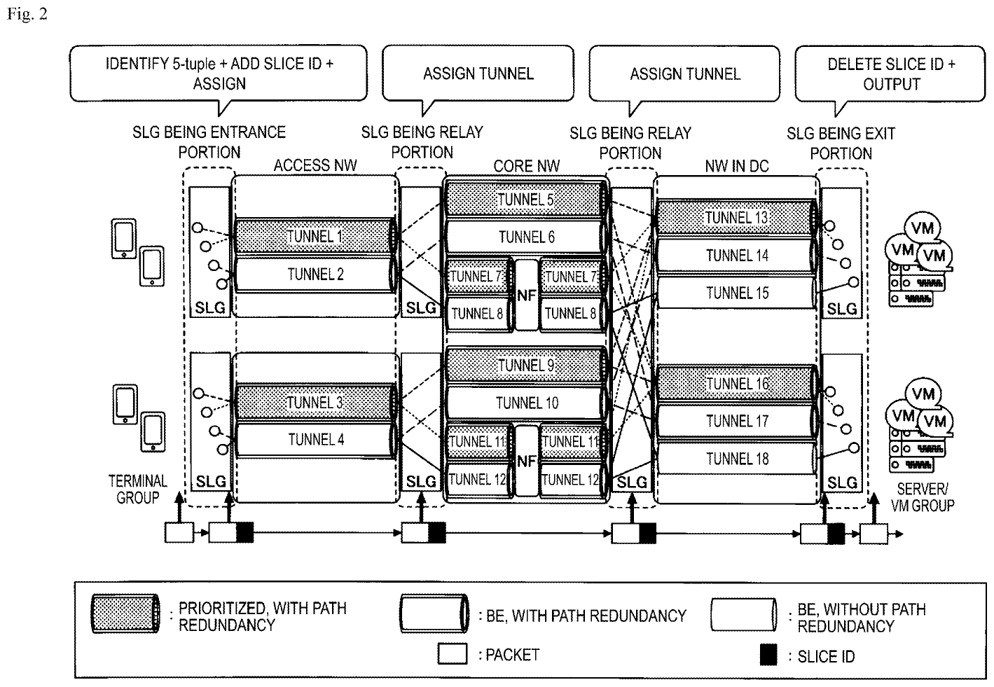

First, an overview of transfer processing by an E2E slice according to the present embodiment will be described. In an NW configuration illustrated in FIG. 2, as described above, it is assumed that an E2E slice is achieved by appropriately connecting tunnels to each other in domains.

When communication from a terminal to a server/VM is performed, in the present embodiment, an SLG being an entrance portion refers to 5-tuple information of a packet transmitted from the terminal, provides a slice ID to a header of the packet, and then assigns the packet into a tunnel corresponding to the slice ID. Here, the slice ID refers to information acquired by abstracting a slice requirement (for example, transfer priority, a quality requirement such as reliability, presence or absence of a passed NF, and the like) and information indicating a destination SLG.

Next, when the packet reaches an SLG being a relay portion, the SLG assigns the packet into a tunnel corresponding to the slice ID. Then, when the packet reaches an SLG being an exit portion, the SLG deletes the slice ID, and outputs the packet to a corresponding server/VM.

In this way, in the transfer processing according to the present embodiment, only an SLG being an entrance portion refers to 5-tuple information and provides a slice ID acquired by abstracting a slice requirement and information indicating a destination SLG to a packet. Then, each SLG assigns a packet into an appropriate tunnel (i.e., a tunnel that satisfies the slice requirement) based on only the slice ID. Thus, the transfer processing according to the present embodiment can eliminate the need to set 5-tuple information at a relay portion and suppress an increase in a transfer table of an SLG and an increase in lead time of assignment setting.

Further, since a slice ID is information acquired by abstracting a slice requirement, each domain can determine a specific transfer method and a specific path. Thus, an NW topology of another domain does not need to be managed. A path change can be handled by only a path change in an own domain, and thus a speed of the path change can be increased.

Note that, in FIG. 2, a case in which communication from a terminal to a server/VM is performed is described as an example, but the same also applies to a case in which communication is performed from the server/VM to the terminal.

Details of Preprocessing and Transfer Processing

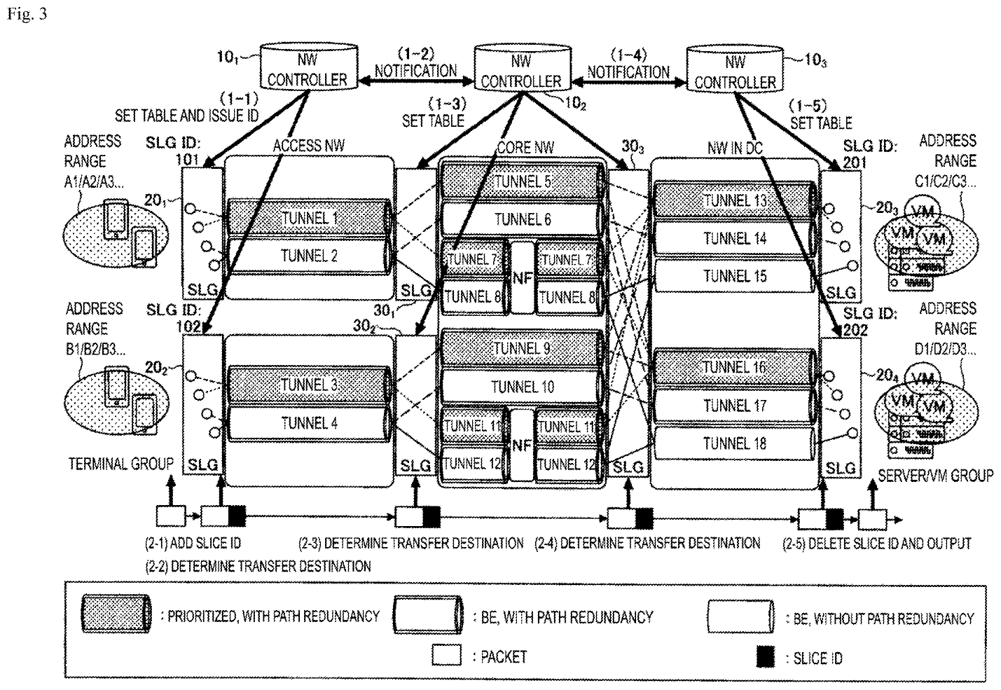

Next, details of the transfer processing illustrated in FIG. 2 and details of preprocessing for achieving the transfer processing will be described with reference to FIG. 3. Hereinafter, it is assumed that each domain includes an NW controller. An NW controller deployed in the access NW is referred to as an “NW controller 10₁”, an NW controller deployed in the core NW is referred to as an “NW controller 10₂” and an NW controller deployed in the NW in DC is referred to as an “NW controller 10₃”. Further, SLGs deployed at an NW endpoint (i.e., SLGs being an entrance portion or an exit portion) are referred to as an “SLG 20₁”, an “SLG 20₂”, an “SLG 20₃”, and an “SLG 20₄”, and SLGs being a relay portion are referred to as an “SLG 30₁”, an “SLG 30₂”, and an “SLG 30₃”. Note that the preprocessing will be described in (1-1) to (1-5), and the transfer processing will be described in (2-1) to (2-5).

(1-1) First, the NW controller 10₁ sets a 5-tuple-slice requirement correspondence table for the SLG 20₁ and the SLG 20₂ at the NW endpoint in its own domain, and also issues an SLG-ID. The SLG-ID is an ID for identifying an SLG deployed at an NW endpoint. Hereinafter, the SLG-ID of the SLG 20₁ is “101”, and the SLG-ID of the SLG 20₂ is “102”.

Note that the NW controller 10₃ also similarly sets a 5-tuple-slice requirement correspondence table for the SLG 20₃ and the SLG 20₄ at the NW endpoint in its own domain, and also issues an SLG-ID. Hereinafter, the SLG-ID of the SLG 20₃ is “201”, and the SLG-ID of the SLG 20₄ is “202”.

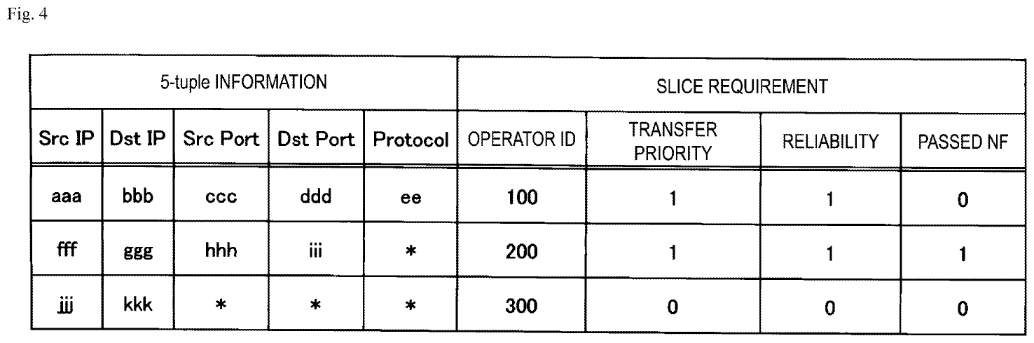

Here, the 5-tuple-slice requirement correspondence table is a table that stores information in which 5-tuple information and a slice requirement are associated with each other. An example of the 5-tuple-slice requirement correspondence table is illustrated in FIG. 4. In the 5-tuple-slice requirement correspondence table illustrated in FIG. 4, SrcIP represents a source IP address, DstIP represents a destination IP address, SrcPort represents a source port number, DstPort represents a destination port number, and Protocol represents a protocol number. Further, an operator ID represents an ID of a service operator who provides application processing and the like, transfer priority represents information indicating priority of transfer (1 when priority is high, and 0 when priority is not high), reliability represents information indicating whether redundancy is necessary (1 when redundancy is necessary, and 0 when redundancy is unnecessary), and a passed NF represents information indicating whether passage through an NF is necessary (1 when passage is necessary, and 0 when passage is unnecessary). Further, an asterisk* represents a wild card. Note that the 5-tuple information and the slice requirement are information provided in advance from, for example, a service operator and the like.

(1-2) The NW controller 10₁ notifies the NW controller 10₂ in an adjacent domain of the SLG ID of the SLG 20 at the NW endpoint in its own domain, an address range subordinate to the SLG 20, and a tunnel ID of a tunnel terminated at the SLG 20 having the SLG ID. Note that the address range is a range of an IP address of a packet received by the SLG 20 deployed at the NW endpoint.

Specifically, the NW controller 10₁ notifies the NW controller 10₂ of (SLG ID “101”, address range “A1/A2/A3 . . . ”, tunnel ID “tunnel 1, tunnel 2”) and (SLG ID “102”, address range “B1/B2/B3 . . . ”, tunnel ID “tunnel 3, tunnel 4”).

Note that the NW controller 10₃ also similarly performs (1-2) described above. In other words, the NW controller 10₃ also similarly provides notification of the SLG ID of the SLG 20 at the NW endpoint in its own domain, an address range subordinate to the SLG 20, and a tunnel ID of a tunnel terminated at the SLG 20 having the SLG ID.

(1-3) When the NW controller 10₂ receives the notification from the NW controller 10 in the adjacent domain, the NW controller 10₂ sets a slice transfer table for the SLG 30 terminating the tunnel having the tunnel ID included in the notification content.

For example, when the NW controller 10₂ receives the notification from the NW controller 10₁, the NW controller 10₂ sets a slice transfer table for the SLG 30₁ that terminates the tunnel 1 and the tunnel 2, and also sets a slice transfer table for the SLG 30₂ that terminates the tunnel 3 and the tunnel 4.

Similarly, when NW controller 10₂ receives the notification from the NW controller 10₃, the NW controller 10₂ sets a slice transfer table for the SLG 30₃ that terminates the tunnel 13 to the tunnel 18.

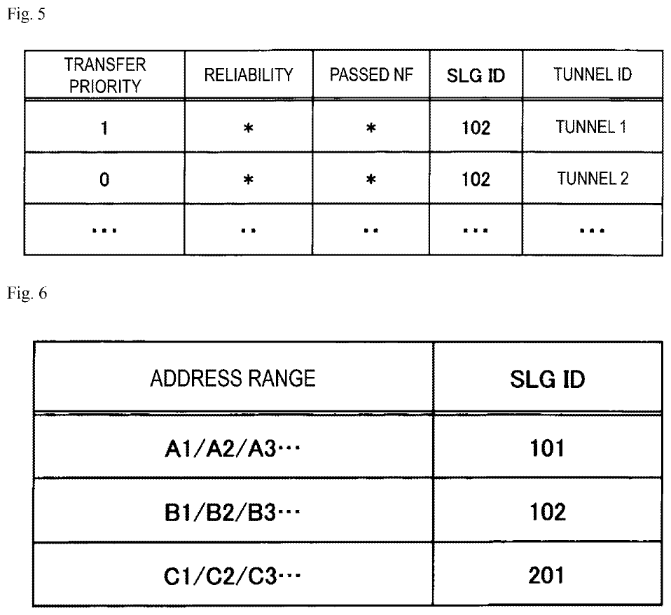

Here, the slice transfer table is a table for determining a transfer destination tunnel. An example of the slice transfer table is illustrated in FIG. 5. The slice transfer table illustrated in FIG. 5 is a table that stores information in which an SLG ID, a tunnel ID, and a transfer setting classification (such as transfer priority, reliability, and a passed NF) of a tunnel having the tunnel ID are associated with one another. Among the pieces of information, the SLG ID and the tunnel ID are an SLG ID and a tunnel ID included in a notification from an NW controller in an adjacent domain. On the other hand, the transfer setting classification of the tunnel is a transfer setting classification (such as transfer priority, reliability, and a passed NF) preset for the tunnel having the tunnel ID.

(1-4) Next, the NW controller 10₂ notifies the NW controller 10 in an adjacent domain other than the original domain that has received the notification in 1-3 described above of an SLG ID and an address range that are included in the notification, and a tunnel ID of a tunnel connecting the SLG 30 in its own domain to an SLG in the adjacent domain.

For example, when the NW controller 10₂ receives the notification from the NW controller 101 in 1-3 described above, the NW controller 102 notifies the NW controller 103 of the NW in DC of an SLG ID “101”, an address range “A1/A2/A3”, an SLG ID “102”, and an address range “B1/B2/B3” that are included in the notification, and a tunnel ID “tunnel 13, tunnel 14, . . . , and tunnel 18” of the tunnel connecting the SLG 30₃ of the core NW to the SLG 20₃ and the SLG 20₄ of the NW in DC.

Similarly, for example, when the NW controller 10₂ receives the notification from the NW controller 10₃ in 1-3 described above, the NW controller 10₂ notifies the NW controller 10₁ of the access NW of an SLG ID “201”, an address range “C1/C2/C3”, an SLG ID “202”, and an address range “D1/D2/D3” that are included in the notification, and a tunnel ID “tunnel 1, tunnel 2, tunnel 3, tunnel 4” of the tunnel connecting the SLG 30₁ and the SLG 30₂ of the core NW to the SLG 20₁ and the SLG 20₁ of the NW in access.

(1-5) Then, when the NW controller 10₃ receives the notification from the NW controller 10₂ of the core NW, the NW controller 10₃ sets, for the SLG 20 that terminates the tunnel ID included in the notification, an SLG ID-address correspondence table in which an SLG ID and an address range that are included in the notification are associated with each other. Further, similarly to 1-3 described above, the NW controller 10₃ sets a slice transfer table for the SLG 20 that terminates the tunnel ID included in the notification.

Note that, when the NW controller 10₁ similarly receives the notification from the NW controller 10₂ of the core NW, the NW controller 10₁ sets a SLG ID-address correspondence table and also sets a slice transfer table for the SLG 20 that terminates the tunnel ID included in the notification.

Here, the SLG ID-address correspondence table is a table for specifying an SLG-ID from an address range. An example of the SLG ID-address correspondence table is illustrated in FIG. 6. The SLG ID-address correspondence table illustrated in FIG. 6 is a table that stores information in which an SLG-ID and an address range are associated with each other.

Note that, for example, when it is assumed that the SLG-ID-address correspondence table illustrated in FIG. 6 is set for the SLG 20₃, a correspondence between the address range “C1/C2/C3 . . . ” and the SLG ID “201” is an obvious correspondence (i.e., a correspondence between the SLG ID of the SLG 20₃ and the address range subordinate to the SLG 20₃). The SLG-ID-address correspondence table also includes such an obvious correspondence.

According to 1-1 to 1-5 described above, the 5-tuple-slice requirement correspondence table, the slice transfer table, and the SLG-ID-address correspondence table are set for each SLG 20 deployed in an endpoint domain (i.e., the access NW and the NW in DC in the example illustrated in FIG. 3); and the slice transfer table is set for each SLG 30 deployed in a relay domain (i.e., the core NW in the example illustrated in FIG. 3). By using these tables, the transfer processing described later provides a slice ID, and determines a transfer destination tunnel (i.e., assigns a packet into a transfer destination tunnel). Note that, in 2-1 to 2-5 below, a case in which a packet is transmitted from the terminal to the server/VM will be described as an example. However, the same also applies to a case in which a packet is transmitted from the server/VM to the terminal.

(2-1) When the SLG 20 deployed in the access NW receives a packet from the terminal, the SLG 20 refers to the 5-tuple-slice requirement correspondence table, and specifies a slice requirement (an operator ID, transfer priority, reliability, and a passed NF) corresponding to the 5-tuple information about the packet. Furthermore, the SLG 20 refers to the SLG-ID-address correspondence table, and specifies an SLG ID corresponding to an address range of a destination IP address included in the 5-tuple information. Then, the SLG 20 provides, as a slice ID, the specified slice requirement and the specified SLG ID to a header of the packet.

(2-2) Next, the SLG 20 refers to the slice transfer table, determines, as a transfer destination, a tunnel having a tunnel ID corresponding to the slice requirement and the SLG ID that are included in the slice ID provided in 2-1 described above (i.e., a tunnel ID corresponding to the transfer priority, the reliability, and the passed NF that are included in the slice requirement, and the SLG ID), and outputs the packet to the tunnel being the transfer destination.

(2-3) When the SLG 30 deployed in the core NW (for example, the SLG 30₂) receives the packet, the SLG 30 refers to the slice transfer table, determines, as a transfer destination, a tunnel having a tunnel ID corresponding to the slice requirement and the SLG ID that are included in the slice ID provided to the packet, and outputs the packet to the tunnel being the transfer destination.

(2-4) Similarly, when the SLG 30 deployed in the core NW (for example, the SLG 30₃) receives the packet, the SLG 30 refers to the slice transfer table, determines, as a transfer destination, a tunnel having a tunnel ID corresponding to the slice requirement and the SLG ID included in the slice ID provided to the packet, and outputs the packet to the tunnel being the transfer destination.

(2-5) Then, when the SLG 20 deployed in the NW in DC (for example, the SLG 20₂) receives the packet, the SLG 20 deletes the slice ID provided to the packet, and then outputs the packet to a corresponding output destination based on a destination IP address, similarly to normal routing and the like.

According to 2-1 to 2-5 described above, an E2E slice is achieved. At this time, in the present embodiment, the SLG 20 being the entrance portion provides a slice ID to a packet based on the 5-tuple information, and thus the SLG 30 being the relay portion can determine a transfer destination tunnel based on only the slice ID. In this way, as described above, it is possible to achieve, for example, suppression of an increase in the transfer table, suppression of an increase in lead time of assignment setting, elimination of management of an NW topology in another domain, speeding up of a path change, and the like.

Functional Configuration

Next, a functional configuration of the NW controller 10, the SLG 20, and the SLG 30 according to the present embodiment will be described. Note that the SLG 20 is a slice gateway deployed in the endpoint domain, and the SLG 30 is a slice gateway deployed in the relay domain.

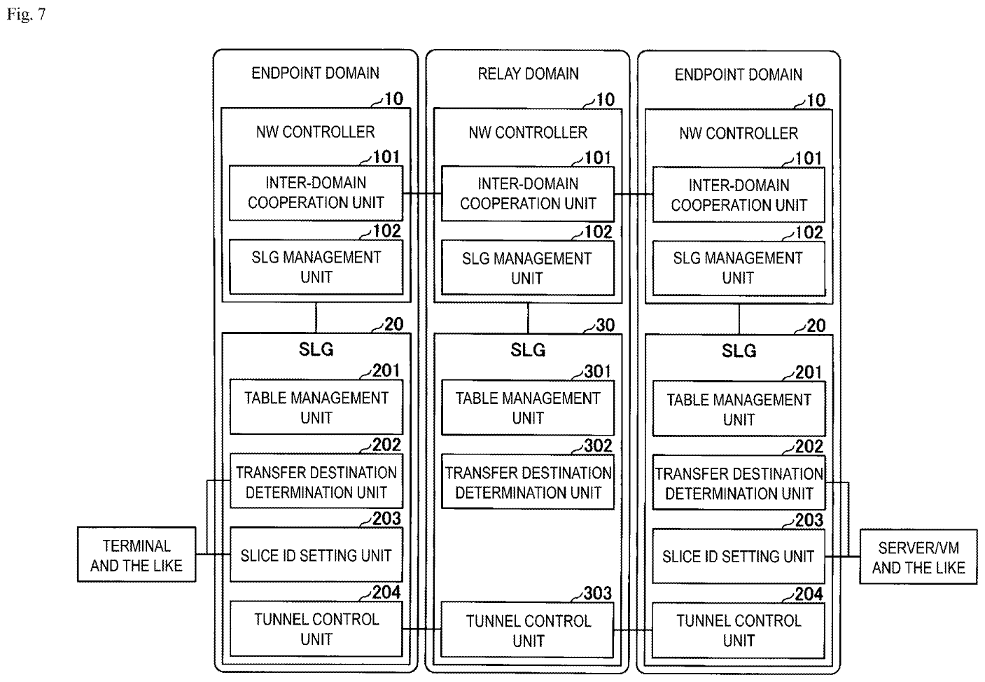

As illustrated in FIG. 7, the NW controller 10 according to the present embodiment includes an inter-domain cooperation unit 101 and an SLG management unit 102. For example, the functional units may be implemented by processing executed by a processor 505 described later with one or more programs installed in the NW controller 10.

When the NW controller 10 is deployed in the endpoint domain, the inter-domain cooperation unit 101 performs various kinds of processing below.
The inter-domain cooperation unit 101 notifies the NW controller 10 in an adjacent domain of an SLG ID issued by the SLG management unit 102, an address range subordinate to the SLG 20 having the SLG ID (i.e., an address range used by a terminal, a server/VM, and the like connected to the SLG 20), and a tunnel ID of a tunnel terminated at the SLG 20.
When the inter-domain cooperation unit 101 receives a notification from the NW controller 10 in an adjacent domain, the inter-domain cooperation unit 101 passes information included in the notification to the SLG management unit 102.

On the other hand, when the NW controller 10 is deployed in the relay domain, the inter-domain cooperation unit 101 performs various kinds of processing below.
When the inter-domain cooperation unit 101 receives a notification from the NW controller 10 in an adjacent domain, the inter-domain cooperation unit 101 notifies the NW controller 10 in another adjacent domain other than the adjacent domain of an SLG ID and an address range that are included in the notification, and a tunnel ID of a tunnel connecting the SLG 30 in its own domain to the SLG (the SLG 20 or the SLG 30) in the other adjacent domain.
When the inter-domain cooperation unit 101 receives a notification from the NW controller 10 in an adjacent domain, the inter-domain cooperation unit 101 passes information included in the notification to the SLG management unit 102.

The SLG management unit 102 manages various kinds of information (for example, tunnel setting between adjacent domains, an address range connected to the SLG 20 when the NW controller 10 is deployed in the endpoint domain, and the like). Further, the SLG management unit 102 sets various tables for each SLG (the SLG 20 or the SLG 30). Various tables described above are the 5-tuple-slice requirement correspondence table, the slice transfer table, and the SLG-ID-address correspondence table when the NW controller 10 is deployed in the endpoint domain, whereas various tables described above are the slice transfer table when the NW controller 10 is deployed in the relay domain. Note that, as described above, the information (i.e., the 5-tuple information and the slice requirement) stored in the 5-tuple-slice requirement correspondence table is information provided in advance from a service operator and the like using a slice, for example.

When the NW controller 10 is deployed in the endpoint domain, the SLG management unit 102 performs various kinds of processing below.
The SLG management unit 102 issues a unique SLG ID for each SLG 20. As a method for issuing an SLG ID, for example, a method for adjusting a range of values settable in advance for each domain among NW operators who manage a domain, using an available value in the range, and the like is conceivable.
The SLG management unit 102 performs, on a slice ID setting unit 203 of the SLG 20, setting that “when the slice ID setting unit 203 receives a packet provided with a slice ID including an SLG ID assigned to the SLG 20, the slice ID setting unit 203 deletes the slice ID”.
The SLG management unit 102 sets, for the SLG 20 that terminates a tunnel having a tunnel ID included in information passed from the inter-domain cooperation unit 101, a table formed of information in which an SLG ID and an address range that are included in the passed information are associated with each other, as an SLG-ID-address correspondence table.
The SLG management unit 102 sets, for the SLG 20 that terminates a tunnel having a tunnel ID included in information passed from the inter-domain cooperation unit 101, a table formed of information in which an SLG ID included in the passed information, a tunnel ID, and a transfer setting classification (such as transfer priority, reliability, and a passed NF) of a tunnel having the tunnel ID are associated with one another, as a slice transfer table.

On the other hand, when the NW controller 10 is deployed in the relay domain, the SLG management unit 102 performs various kinds of processing below.
The SLG management unit 102 sets, for the SLG 30 that terminates a tunnel having a tunnel ID included in information passed from the inter-domain cooperation unit 101, a table formed of information in which an SLG ID included in the passed information, a tunnel ID, and a transfer setting classification (such as transfer priority, reliability, and a passed NF) of a tunnel having the tunnel ID are associated with one another, as a slice transfer table.

As illustrated in FIG. 7, the SLG 20 according to the present embodiment includes a table management unit 201, a transfer destination determination unit 202, the slice ID setting unit 203, and a tunnel control unit 204. For example, the functional units may be implemented by processing executed by a processor 603 described later with one or more programs installed in the SLG 20.

The table management unit 201 manages a 5-tuple-slice requirement correspondence table, a slice transfer table, and an SLG-ID-address correspondence table that are set from the SLG management unit 102. Note that these tables are stored in a memory device 604 described later, for example.

The transfer destination determination unit 202 performs various kinds of processing below based on an SLG ID and a slice requirement (such as transfer priority, reliability, and a passed NF) that are included in a slice ID provided to a packet.
The transfer destination determination unit 202 refers to the slice transfer table, and specifies a tunnel ID corresponding to a slice requirement and an SLG ID that are included in a slice ID provided to a packet.
The transfer destination determination unit 202 requests the tunnel control unit 204 to perform processing of outputting the packet from the tunnel ID specified described above.

Further, the transfer destination determination unit 202 outputs a packet to a terminal, a server/VM, and the like by normal routing and the like when a slice ID is not provided to the packet (i.e., when a slice ID is deleted from the packet).

The slice ID setting unit 203 refers to the 5-tuple-slice requirement correspondence table, and specifies a slice requirement corresponding to 5-tuple information included in a packet received from the terminal, the server/VM, or the like. Furthermore, the slice ID setting unit 203 refers to the SLG-ID-address correspondence table, and specifies an SLG ID corresponding to a destination IP address included in the 5-tuple information. The slice ID setting unit 203 provides, as a slice ID, the specified slice requirement and the specified SLG ID to a header of the packet. Then, the slice ID setting unit 203 requests the transfer destination determination unit 202 to process the packet provided with the slice ID.

When the slice ID setting unit 203 is requested to process the packet from the tunnel control unit 204, the slice ID setting unit 203 confirms the SLG ID included in the slice ID provided to the packet and determines whether the SLG ID matches an SLG ID assigned to itself. Then, when the SLG ID included in the slice ID matches the SLG ID assigned to itself, the slice ID setting unit 203 deletes the slice ID from the packet, and then requests the transfer destination determination unit 202 to process the packet. On the other hand, when the SLG ID included in the slice ID does not match the SLG ID assigned to itself, the slice ID setting unit 203 abandons the packet as an invalid packet.

The tunnel control unit 204 performs termination processing of a tunnel (for example, provision of a header for a tunnel (tunnel header) when a packet is to be output (transmitted), and deletion of a tunnel header when a packet is received). At this time, the tunnel control unit 204 provides an appropriate value to a field (for example, a type of service (ToS) field in a case of an IP header, and the like) indicating transfer priority of a tunnel header in accordance with transfer priority set for each tunnel, and also performs priority control (for example, priority queuing, and the like) of a packet encapsulated in the tunnel header in accordance with the transfer priority.

Further, when the tunnel control unit 204 receives the packet from the SLG 30 in the adjacent domain, the tunnel control unit 204 performs the termination processing described above (i.e., deletion of the packet header), and then requests the slice ID setting unit 203 to process the packet.

As illustrated in FIG. 7, the SLG 30 according to the present embodiment includes a table management unit 301, a transfer destination determination unit 302, and a tunnel control unit 303. For example, the functional units may be implemented by processing executed by the processor 603 described later with one or more programs installed in the SLG 30.

The table management unit 301 manages a slice transfer table set from the SLG management unit 102. Note that the slice transfer table is stored in the memory device 604 described later, for example.

The transfer destination determination unit 302 performs various kinds of processing below based on an SLG ID and a slice requirement (such as transfer priority, reliability, and a passed NF) that are included in a slice ID provided to a packet.
The transfer destination determination unit 302 refers to the slice transfer table, and specifies a tunnel ID corresponding to a slice requirement and an SLG ID that are included in a slice ID provided to a packet.
The transfer destination determination unit 302 requests the tunnel control unit 204 to perform processing of outputting the packet from the tunnel ID specified described above.

The tunnel control unit 303 performs termination processing of a tunnel (for example, provision of a header for a tunnel (tunnel header) when a packet is to be output (transmitted), and deletion of a tunnel header when a packet is received). At this time, the tunnel control unit 204 provides an appropriate value to a field (for example, a type of service (ToS) field in a case of an IP header, and the like) indicating transfer priority of a tunnel header in accordance with transfer priority set for each tunnel, and also performs priority control (for example, priority queuing, and the like) of a packet encapsulated in the tunnel header in accordance with the transfer priority.

Further, when the tunnel control unit 204 receives the packet from the SLG (the SLG 20 or the SLG 30) in the adjacent domain, the tunnel control unit 204 performs the termination processing described above (i.e., deletion of the packet header), and then requests the transfer destination determination unit 302 to process the packet.

Flow of Transfer Processing in Example

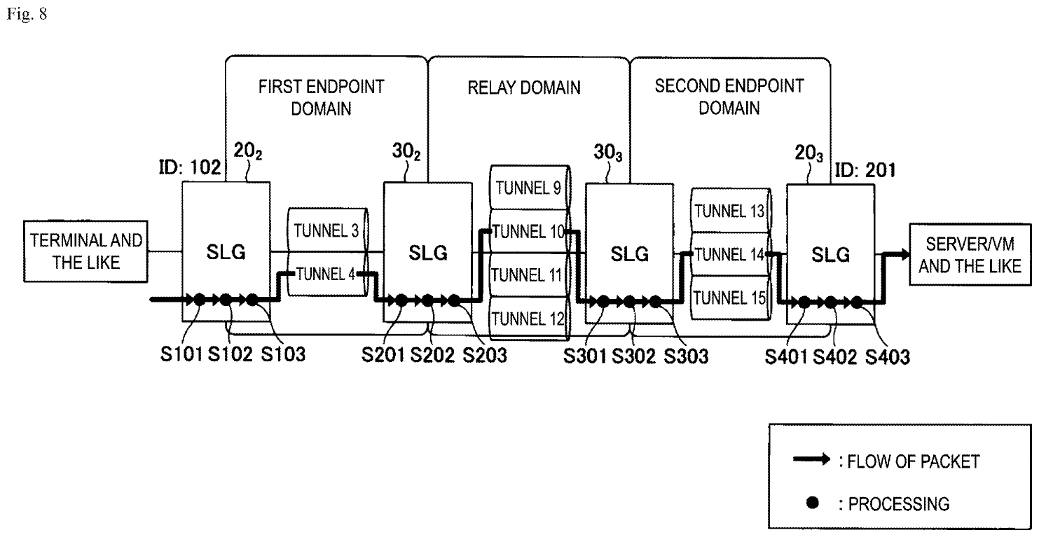

Hereinafter, as an example, in the NW configuration illustrated in FIG. 3, transfer processing when a packet from the terminal of the address range “B1/B2/B3 . . . ” is transmitted to the server/VM and the like of the address range “C1/C2/C3 . . . ” via a slice achieved by connecting the tunnel 4, the tunnel 10, and the tunnel 14 will be described with reference to FIG. 8.

S101: First, the slice ID setting unit 203 of the SLG 202 refers to the 5-tuple-slice requirement correspondence table and specifies a slice requirement corresponding to 5-tuple information included in the packet from the terminal and also refers to the SLG-ID-address correspondence table and specifies an SLG ID “201” corresponding to a destination IP address included in the 5-tuple information. Then, the slice ID setting unit 203 of the SLG 20₂ provides, as a slice ID, the specified slice requirement and the specified SLG ID “201” to a header of the packet, and then requests the transfer destination determination unit 202 to process the packet.

S102: Next, the transfer destination determination unit 202 of the SLG 20₂ refers to the slice transfer table, and specifies (determines) a tunnel ID “4” corresponding to the slice requirement and the SLG ID “201” that are included in the slice ID provided to the packet in S101 described above. Then, the transfer destination determination unit 202 of the SLG 20₂ requests the tunnel control unit 204 to process the packet.

S103: Next, the tunnel control unit 204 of the SLG 20₂ encapsulates the packet in a tunnel header of a tunnel corresponding to the tunnel ID “4” determined in S102 described above, and then outputs the packet from the tunnel having the tunnel ID “4”. Note that, at this time, transfer priority and the like are set for the tunnel header.

S201: Next, when the tunnel control unit 303 of the SLG 30₂ receives the packet via the tunnel having the tunnel ID “4”, the tunnel control unit 303 deletes the tunnel header from the packet. Then, the tunnel control unit 303 of the SLG 30₂ requests the transfer destination determination unit 302 to process the packet.

S202: Next, the transfer destination determination unit 302 of the SLG 30₂ refers to the slice transfer table, and specifies (determines) a tunnel ID “10” corresponding to the slice requirement and the SLG ID “201” that are included in the slice ID provided to the packet having the tunnel header deleted in S201 described above. Then, the transfer destination determination unit 302 of the SLG 30₂ requests the tunnel control unit 303 to process the packet.

S203: Next, the tunnel control unit 303 of the SLG 30₂ encapsulates the packet in a tunnel header of a tunnel corresponding to the tunnel ID “10” determined in S202 described above, and then outputs the packet from the tunnel having the tunnel ID “10”. Note that, at this time, transfer priority and the like are set for the tunnel header.

S301: Next, when the tunnel control unit 303 of the SLG 30₃ receives the packet via the tunnel having the tunnel ID “10”, the tunnel control unit 303 deletes the tunnel header from the packet. Then, the tunnel control unit 303 of the SLG 30₃ requests the transfer destination determination unit 302 to process the packet.

S302: Next, the transfer destination determination unit 302 of the SLG 30₃ refers to the slice transfer table, and specifies (determines) a tunnel ID “14” corresponding to the slice requirement and the SLG ID “201” that are included in the slice ID provided to the packet having the tunnel header deleted in S301 described above. Then, the transfer destination determination unit 302 of the SLG 30₃ requests the tunnel control unit 303 to process the packet.

S303: Next, the tunnel control unit 303 of the SLG 30₃ encapsulates the packet in a tunnel header of a tunnel corresponding to the tunnel ID “14” determined in S302 described above, and then outputs the packet from the tunnel having the tunnel ID “14”. Note that, at this time, transfer priority and the like are set for the tunnel header.

S401: Next, when the tunnel control unit 204 of the SLG 20₃ receives the packet via the tunnel having the tunnel ID “14”, the tunnel control unit 204 deletes the tunnel header from the packet. Then, the tunnel control unit 204 of the SLG 20₃ requests the slice ID setting unit 203 to process the packet.

S402: Next, the slice ID setting unit 203 of the SLG 20₃ determines whether the SLG ID “201” included in the slice ID provided to the packet having the tunnel header deleted in S401 described above matches the SLG ID “201” of itself. In the present example, since these SLG IDs are determined to match, the tunnel control unit 204 of the SLG 20₃ deletes the slice ID provided to the packet. Then, the slice ID setting unit 203 of the SLG 20₃ requests the transfer destination determination unit 202 to process the packet.

S403: Next, since the slice ID is not provided to the packet, the transfer destination determination unit 202 of the SLG 20₃ outputs the packet to the terminal, the server/VM, and the like by normal routing and the like (i.e., routing according to a destination IP address, and the like).

As described above, the packet from the terminal is transmitted to the server/VM and the like via the slice. Note that, in FIG. 8, a case in which the packet is transmitted from the terminal to the server/VM and the like is described, but the same also applies to a case in which the packet is transmitted from the server/VM and the like to the terminal.

Hardware Configuration

Lastly, a hardware configuration of the NW controller 10, the SLG 20, and the SLG 30 according to the present embodiment will be described.

NW Controller 10

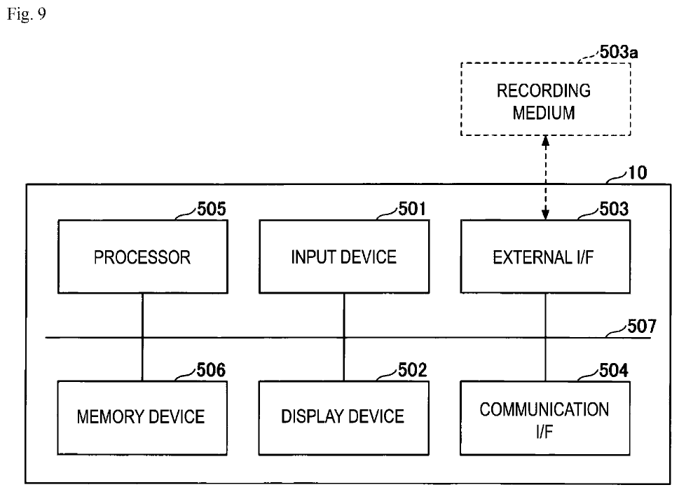

As illustrated in FIG. 9, the NW controller 10 according to the present embodiment includes an input device 501, a display device 502, an external I/F 503, a communication I/F 504, the processor 505, and a memory device 506. The pieces of hardware are communicatively connected via a bus 507.

The input device 501 is a keyboard, a mouse, or a touch panel, for example. The display device 502 is, for example, a display. Note that the NW controller 10 does not necessarily include at least one of the input device 501 and the display device 502.

The external I/F 503 is, for example, an interface with an external device such as a recording medium 503a. Examples of the recording medium 503a include a compact disc (CD), a digital versatile disc (DVD), a secure digital memory card (SD memory card), and a universal serial bus (USB) memory card.

The communication I/F 504 is an interface for connection with a communication network. The processor 505 is, for example, an arithmetic operation device such as a central processing unit (CPU). The memory device 506 is, for example, any storage device such as a hard disk drive (HDD), a solid state drive (SSD), a random access memory (RAM), a read only memory (ROM), or a flash memory.

The NW controller 10 according to the present embodiment has the hardware configuration illustrated in FIG. 9 and thus can implement various kinds of processing described above. Note that the hardware configuration illustrated in FIG. 9 is an example, and the NW controller 10 may have another hardware configuration. For example, the NW controller 10 may include a plurality of processors 505 and may include a plurality of memory devices 506.

SLG 20 and SLG 30

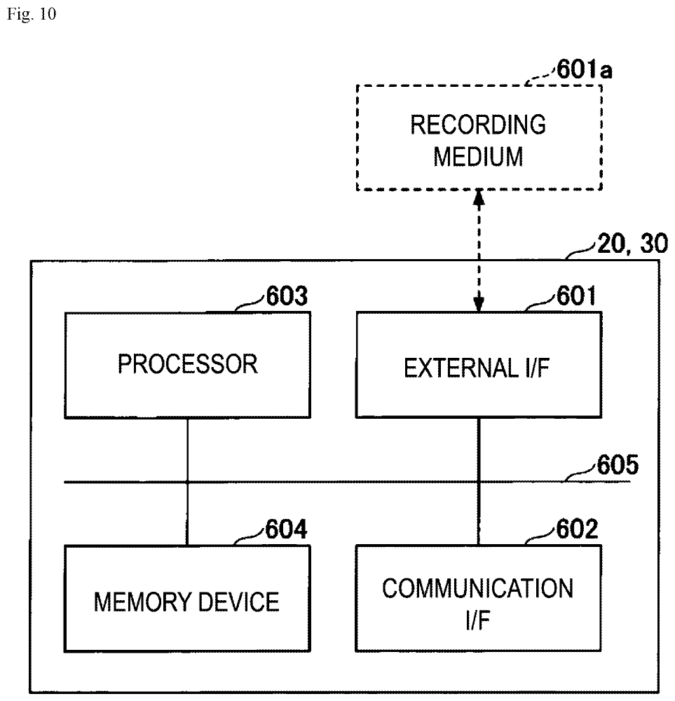

As illustrated in FIG. 10, the SLG 20 and the SLG 30 according to the present embodiment include an external I/F 601, a communication I/F 602, the processor 603, and the memory device 604. The pieces of hardware are communicatively connected via a bus 605.

The external I/F 601 is an interface with an external device such as a recording medium 601a. Note that examples of the recording medium 601a include a micro SD, a USB memory card, and the like.

The communication I/F 602 is an interface for connection with a communication network. The processor 603 is an arithmetic operation device such as a CPU. The memory device 604 is any of various storage devices such as a flash memory, a RAM, and a ROM.

The SLG 20 and the SLG 30 according to the present embodiment have the hardware configuration illustrated in FIG. 10 and thus can implement various processing operations described below. Note that the hardware configuration illustrated in FIG. 10 is an example, and the SLG 20 and the SLG 30 may have another hardware configuration. For example, the SLG 20 and the SLG 30 may have a plurality of processors 603 or may have a plurality of memory devices 604.

The present invention is not limited to the above-described embodiment disclosed specifically, and various modifications or changes, combinations with known techniques, and the like can be made without departing from description of the claims.

### REFERENCE SIGNS LIST

10 NW controller

20 SLG

30 SLG

101 Inter-domain cooperation unit

102 SLG management unit

201 Table management unit

202 Transfer destination determination unit

203 Slice ID setting unit

204 Tunnel control unit

301 Table management unit

302 Transfer destination determination unit

303 Tunnel control unit

1. A gateway apparatus, comprising:
a processor; and
a memory storing program instructions that cause the processor to:
refer to a slice transfer table for selecting a tunnel for a transfer destination in response to receiving a packet to which a slice ID is added, the slice ID including an abstracted slice requirement indicating a requirement related to transfer priority, reliability, and whether a network function is passed through and an abstracted gateway ID indicating a gateway apparatus as a destination;
specify a tunnel corresponding to the slice requirement and the gateway ID that are included in the slice ID; and
transfer the packet via the specified tunnel.

2. The gateway apparatus according to claim 1, wherein the program instructions further cause the processor to create the slice ID from 5-tuple information included in a packet when the packet is received from a terminal, a server, or a virtual machine, and to add the slice ID created to the packet.

3. The gateway apparatus according to claim 2, wherein the program instructions further cause the processor to
refer to an ID-address correspondence table for specifying the gateway ID indicating a gateway apparatus as a destination,
specify the gateway ID corresponding to a destination IP address included in the 5-tuple information,
refer to a 5-tuple-slice requirement correspondence table for specifying the slice requirement,
specify the slice requirement corresponding to the 5-tuple information, and
add the slice ID, to the packet, the slice ID being the specified gateway ID and the specified slice requirement.

4. The gateway apparatus according to claim 1, wherein the program instructions further cause the processor to:
determine whether the gateway ID included in the slice ID matches the gateway ID assigned to the gateway apparatus itself in a case where a packet with the slice ID added is received; and
delete the slice ID from the packet received when the gateway ID included in the slice ID is determined to matche the gateway ID assigned to the gateway apparatus itself, wherein
route the packet with the slice ID added according to a destination IP address included in the packet.

5. A method executed by a computer, comprising:
referring to a slice transfer table for selecting a tunnel for a transfer destination in response to receiving a packet to which a slice ID is added, the slice ID including an abstracted slice requirement indicating a requirement related to transfer priority, reliability, and whether a network function is passed through and an abstracted gateway ID indicating a gateway apparatus as a destination and specifying a tunnel corresponding to the slice requirement and the gateway ID that are included in the slice ID; and
transferring the packet via the tunnel specified by the specifying.

6. A non-transitory computer-readable storage medium that stores therein a program causing a computer including a memory and a processor to operate as the gateway apparatus according to claim 1.
